(19) United States
(12) Patent Application Publication
(10) Pub. No.: US 2024/0348749 A1
(43) Pub. Date: Oct. 17, 2024

(54) CAMERA SYSTEM, AND METHOD FOR GENERATING A VIEW USING A CAMERA SYSTEM

(71) Applicant: Continental Autonomous Mobility Germany GmbH, Ingolstadt (DE)

(72) Inventors: Charlotte Gloger, Ulm (DE); Frank Kittmann, Ulm (DE); Markus Friebe, Gefrees (DE)

(73) Assignee: Continental Autonomous Mobility Germany GmbH, Ingolstadt (DE)

(21) Appl. No.: 18/579,735

(22) PCT Filed: Jun. 24, 2022
(86) PCT No.: PCT/DE2022/200141

§ 371 Date: Jan. 16, 2024

(30) Foreign Application Priority Data
Jul. 15, 2021 (DE) 10 2021 207 558.4

(51) Int. Cl. H04N 7/18; H04N 23/698

(52) U.S. Cl. CPC H04N 7/181; H04N 23/698

(57) ABSTRACT

The present disclosure relates to a camera system, in particular a surround-view camera system for a vehicle, including a control device, multiple cameras arranged in/on the vehicle, and a controller which is arranged in/on an additional vehicle, in particular a trailer. Multiple additional cameras or trailer cameras are arranged in/on the additional vehicle or trailer. The control device generates a view by means of the cameras. The controller generates a view by means of the trailer cameras, and a combined view is generated from the views of the control device and the controller.

### CROSS-REFERENCE TO RELATED APPLICATION

The present application is a National Stage Application under 35 U.S.C. § 371 of International Patent Application No. PCT/DE2022/200141 filed on Jun. 24, 2022, and claims priority from German Patent Application No. 10 2021 207 558.4 filed on Jul. 15, 2021, in the German Patent and Trademark Office, the disclosures of which are herein incorporated by reference in their entireties.

### TECHNICAL FIELD

The present invention relates to a camera system, in particular a surround-view camera system, for capturing the environment for a vehicle, as well as a method for generating a view using a camera system, for a vehicle having an additional vehicle (trailer), wherein a camera system according to the invention is provided as the camera system.

### BACKGROUND

Modern vehicles are increasingly being equipped with driver assistance systems which support the driver during the performance of driving maneuvers. In addition to radar sensors, lidar sensors, ultrasonic sensors and/or camera sensors, the driver assistance systems also include, in particular, surround-view camera systems which allow the vehicle surroundings to be displayed to the driver of the vehicle. As a general rule, such surround-view camera systems include a control device and multiple cameras which supply real images of the vehicle surroundings that are merged in particular by a data processing unit of the surround-view camera system to form an image of the vehicle surroundings. The image of the vehicle surroundings is then displayed to the driver on a display unit (such as, e.g., the display of the navigation system). In this way, the driver can be supported during a vehicle maneuver, for example when reversing the vehicle or during a parking maneuver. Furthermore, the surround-view cameras are, as a general rule, fisheye cameras, i.e., a camera having a fisheye lens, which supply a fisheye image. The undistorted fisheye images are then used to represent various views of the surroundings to the driver such as, e.g., front view, back view, curb view and the like.

Furthermore, the images can also be merged into a 360° panoramic view so that the driver can select the suitable focal point by moving within a scene of a virtual camera. In this case, there are various functions or views such as “bowl” or “top view” (“birds eye's view” or “plan view”), in which images or textures from the surround-view cameras are merged or seamlessly strung together (stitching) to form an overall view (or overall texture). As a general rule, the images or textures of the surround-view cameras have overlapping areas or overlapping regions-in particular in the bowl view, in which the textures from the cameras are projected in order to visualize a virtual 3D bowl which represents the entire area around the car. Modern surround-view camera systems can then display the resulting, generated views to the driver, e.g., on a display, a cockpit or a navigation system.

Nowadays, generic surround-view systems can, for the most part, be extended by up to four additional or trailer cameras on the outside of an additional vehicle, in particular a trailer, if the vehicle is to be operated together with the trailer. For example, a trailer camera on the front side, a trailer camera on the back side and one trailer camera respectively on each side of the trailer. Thanks to the increased image resolution, this can reach a considerable size during the transmission of the data to the car. Moreover, there are some restrictions regarding the supported length of the cable for connecting the trailer cameras to the control device in the vehicle. A possible solution is to therefore integrate a separate controller in the trailer, which collects the camera data from the trailer cameras and forwards the data to the control device in the vehicle. Nevertheless, the bandwidth between the controller of the trailer and the control device of the vehicle is, as a general rule, not sufficient in order to go through, e.g., four image streams.

A three-dimensional all-round view system for a combination of a vehicle and a trailer is known from DE 10 2016 224 904 A1, wherein the trailer is fixed to the vehicle with the aid of a straight drawbar in an articulated manner about a vertical axis of the vehicle. The all-round view system includes multiple cameras of the vehicle, multiple cameras of the trailer, an image processing unit and an optical output unit. The image processing unit is designed to determine a first rotational angle about which the drawbar is rotated relative to the vehicle about the vertical axis thereof relative to a forward direction of the vehicle from an image acquired by one of the cameras of the vehicle. An image region of a vehicle all-round image produced by the cameras of the vehicle, the image region being covered by the trailer, is replaced by a corresponding image region of a trailer all-round image produced by the cameras of the trailer on the basis of the determined first rotational angle of the drawbar. In this way, a three-dimensional all-round image of the entire combination can be represented on the display unit.

In order to generate a 3D view in a surround-view system, the four cameras of the car are, as a general rule, used and projected on a bowl representation (“bowl”). The blind spot of the cameras, that is to say the region under the car, is covered and a 3D car model is rendered into the scene. For a 3D view including the trailer, this approach can be extended to eight cameras, including the four cameras of the trailer. During the creation of 3D views, all of the necessary camera images for image processing are loaded into the cache. In general, the cache size in embedded surround-view systems is not large enough to process all four camera images simultaneously. Admittedly, this can lead to cache faults and increased processing time.

Furthermore, a surround-view system for a vehicle for towing trailers, in which the generation of the surround-view image is carried out by merging all of the camera images of the vehicle and trailer in a common controller, is known from US 2017 341 583 A1.

EP 3 318 469 A1 describes a method for creating a surround-view image for a vehicle having a trailer as well as the superimposition/merging of both as a function of the alignment of the trailer.

U.S. Pat. No. 9,860,445 B2 describes a trailer assistance system, wherein two surround-view images generated by stitching in two separate controllers (ECU-Electronic Control Unit) are merged to form a joint surround-view 2D view (top view/bird's eye view).

### SUMMARY

The problem of the present disclosure is to therefore make available a generic (surround-view) camera system which simplifies the communication between the trailer and the vehicle and improves it in a cost-effective manner and reduces the probability of faults.

The aforementioned problem is addressed by the entire teaching of Claim 1 as well as any alternative, independent claim. Expedient configurations of the present disclosure are claimed in the subclaims.

The camera system according to the present disclosure, in particular a surround-view camera system for a vehicle, includes a control device, multiple (surround-view) cameras arranged in/on the vehicle, a controller which is arranged in/on an additional vehicle (in particular a trailer), and multiple additional cameras or trailer cameras which are arranged in/on the additional vehicle. The control device generates a view by means of the cameras on the vehicle or the streams/images/data from the surround-view cameras, while the controller generates a view by means of the additional cameras or trailer cameras or the streams/images/data from the trailer cameras. Following this, a combined view is generated from the views of the control device and the controller. The method according to the present disclosure reduces the required bandwidth and the number of images which are required simultaneously in the cache, as a result of which the communication between the trailer and the vehicle is particularly simplified and improved. Instead of three or four camera streams, only one image has to be transmitted from the trailer controller to the vehicle's control device for each frame. With this approach, each controller only has to process four camera streams at a specific time, which reduces memory consumption and the chances of a cache fault during processing. In addition, the method described can be implemented in a particularly simple and cost-effective manner and can also be retrofitted in existing systems.

A 2D view, in particular a top view, or a 3D view, in particular a bowl view or a bowl, may be provided as the view. Alternatively, however, another 3D view may also be generated, wherein the control device and the controller may also generate different views which are, however, later combined to form a 3D view type.

The view may be expediently combined, taking account of the length and/or width of the vehicle combination, i.e., vehicle and trailer, or a part of the vehicle combination. As a result, the entire vehicle combination may be easily visualized in a 2D/3D representation in the vehicle and, consequently, displayed to the driver.

According to a particular configuration of the present disclosure, the view may also be combined taking account of the angle between the vehicle and the trailer. As a result, the view may be generated even more precisely.

The combined view may represent an extension, taking account of the 3D view of the control device and/or the view of the controller.

Furthermore, the view of the controller may be transmitted by the controller to the control device and the control device generates the combined view.

In order to generate the view, the controller may expediently enlist a virtual camera, the position of which substantially corresponds to the position of the camera of the vehicle which is directed toward the trailer, i.e., the rear-facing surround-view camera or reversing camera.

In an alternative, independent claim, the present disclosure is also directed to a method for generating a view using a camera system for a vehicle having an additional vehicle or trailer, wherein a camera system according to the present disclosure is provided as the camera system.

### BRIEF DESCRIPTION OF THE DRAWINGS

The invention is explained in greater detail below with reference to expedient exemplary embodiments, wherein:

FIG. 1 shows a simplified schematic representation of a configuration of a vehicle having a surround-view camera system according to the present disclosure;

FIG. 2 shows a significantly simplified schematic representation of the vehicle from FIG. 1 having a trailer;

FIG. 3 shows a simplified schematic representation of a configuration of a bowl which was generated with the method according to the present disclosure;

FIG. 4 shows a simplified schematic representation of a further configuration of the bowl from FIG. 3, which was expanded;

FIG. 5 shows a simplified schematic representation of a further configuration of the bowl from FIG. 4, which was extended by the back view of the trailer reversing camera;

FIG. 6 shows a simplified schematic representation of a further embodiment of the bowl from FIG. 5, in which the models for the vehicle and trailer are inserted, and

FIG. 7 shows simplified schematic representations (a)-(c) of different expansions of a bowl as a function of the length and orientation of the trailer.

### DETAILED DESCRIPTION

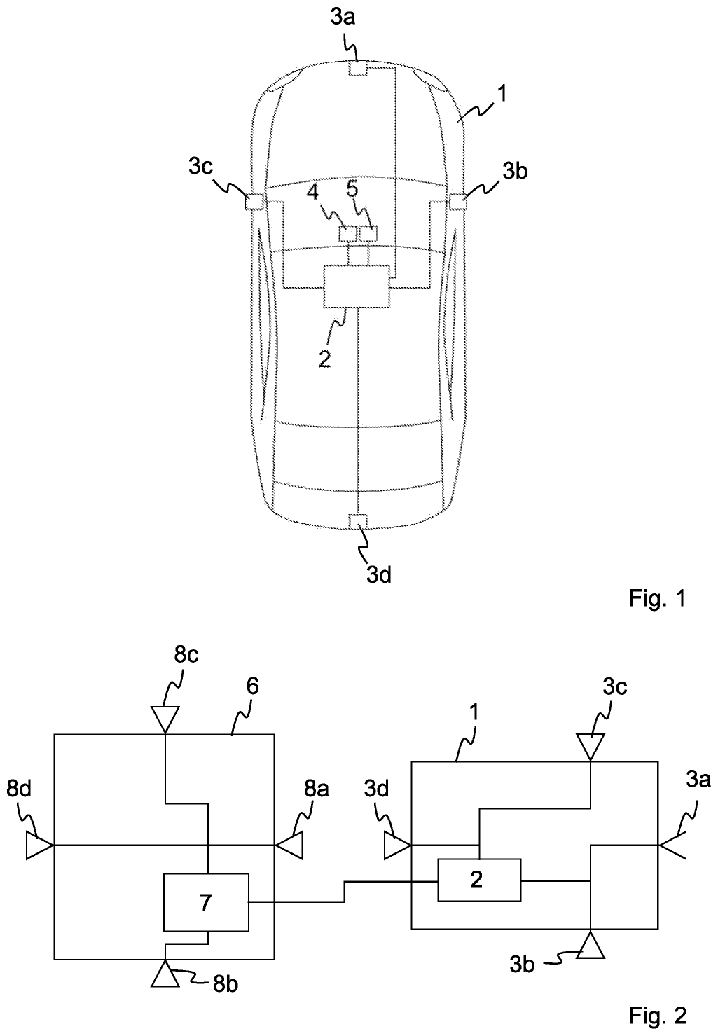

Reference numeral 1 in FIG. 1 designates a vehicle having a control device 2 (ECU, Electronic Control Unit or ADCU, Assisted and Automated Driving Control Unit), which can have recourse to various actuators (e.g., steering, engine, brake) of the vehicle 1 in order to be able to carry out control processes of the vehicle 1. Furthermore, the vehicle 1 has multiple surround-view cameras or cameras 3a-3d, a camera sensor 4 (or front camera) and a lidar sensor 5, which are controlled via the control device 2, for capturing the environment. However, the present disclosure also expressly includes configurations in which no common control device 2 is provided, but rather individual control devices or control units for controlling the sensors are provided (e.g., a separate control unit or a separate controller for controlling the cameras 3a-3d, for corresponding data processing and for performing the method according to the present disclosure). Moreover, further sensors such as, e.g., radar or ultrasonic sensors may also be provided. The sensor data may then be utilized for recognizing the environment and objects. As a consequence, various assistance functions such as, e.g., parking assistants, Electronic Brake Assist (EBA), Adaptive Cruise Control (ACC), a Lane Departure Warning System or a Lane Keep Assist (LKA) or the like may be realized. In a practical manner, the assistance functions may likewise be carried out via the control device 2 or a separate control device.

The cameras 3a-3d are part of a surround-view camera system which may be controlled by the control device 2 (alternatively, e.g., a separate control may be provided), which provides a complete 360-degree view around the entire vehicle 1 by joining the fields of view of the individual surround-view cameras, e.g., 120 degrees, to form an overall view or overall image. By simply monitoring the blind spot, this camera system has numerous advantages in many everyday situations. Various viewing angles of the vehicle 1 may be represented to the driver by the surround-view camera system, e.g., via a display unit (not shown in FIG. 1). As a general rule, four surround-view cameras 3a-3d are used, which are arranged, e.g., in the front and back region as well as on the side mirrors. In addition, three, six, eight, ten or more surround-view cameras may, however, also be provided. These camera views or viewing angles are particularly helpful when checking the blind spot, changing lanes or parking.

A simplified view of the vehicle 1 is depicted in FIG. 2, in which an additional vehicle or a trailer 6 is fixed to the vehicle 1 via a trailer apparatus. The trailer 6 includes a controller 7 and four trailer cameras 8a-8d, the data or streams of which may be collected by the controller 7 which, in turn, may transmit the data to the control device 2 (e.g., in a wired manner or via radio), e.g., as an image or preliminary stage thereof.

Furthermore, the controller 7 for the trailer 6 may serve to look at the four camera images of the trailer 6 from the rear camera position (rear camera 3d) of the vehicle 1 in 3D. The intrinsic and extrinsic values of the camera 3d can be indicated to the controller 7 when starting up.

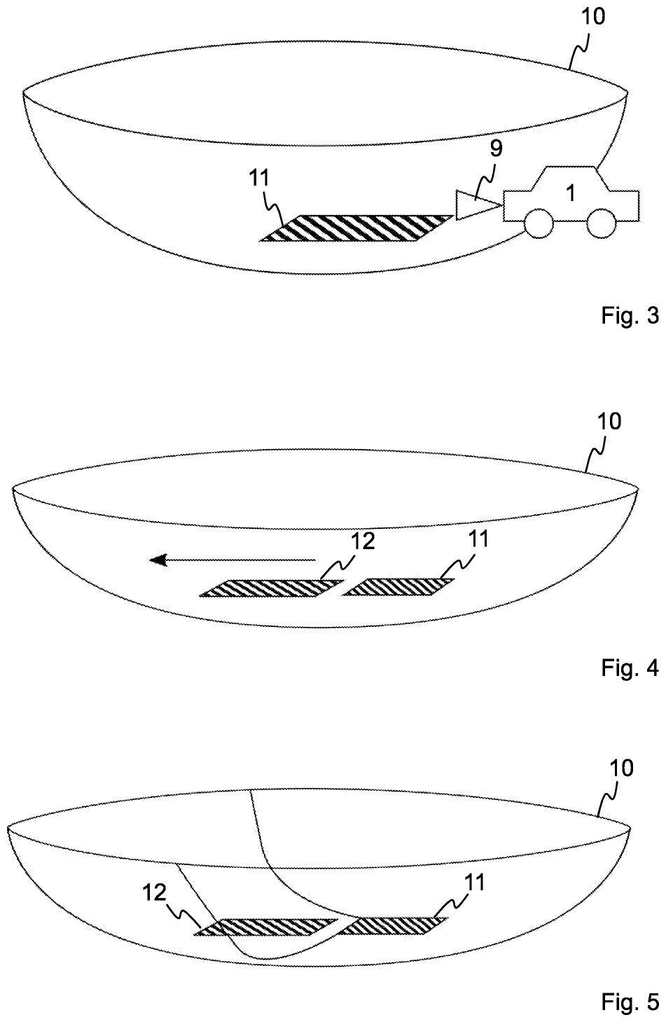

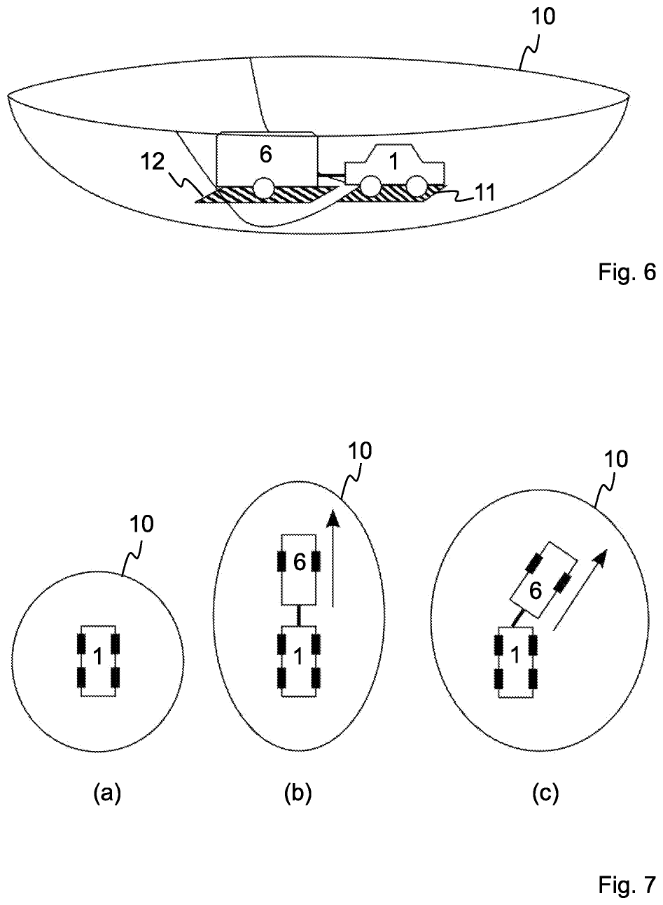

A 3D bowl geometry or bowl 10 is generated on the controller 7, wherein the position of the trailer 6 is the center of the bowl 10. The four cameras 8a-8d of the trailer 6 are used for the texture of the 3D bowl. The controller 7 may also cover the blind spots of the cameras 8a-8d of the trailer via known algorithms, i.e., the area 11 under the trailer 6 as well as all the bodywork parts of the trailer 6, as depicted in FIG. 3. The bottom area of the bowl 10 is enlarged (as shown in FIG. 4 by means of the black arrow pointing in the direction of the trailer 6) in order to also include the trailer 6 behind the vehicle 1. After that, both the blind spot under the vehicle or area 12 and the parts of the bodywork visible from the vehicle are covered. The 3D view is then represented, wherein a virtual camera position corresponds to the rear camera position of the real vehicle and is ideally a 180° horizontal field of view. Although a smaller field of view would also work, a 180° field of view imitates a surround-view rear camera particularly well. The produced view is then sent to the control device 2 and replaces the rear-camera stream there in the case of the 3D view (as shown in FIG. 5 by means of the delimitation between the rear-camera stream and the remaining streams). As a final step, the 3D vehicle and trailer model may then be included in the 3D view (as shown in FIG. 6). The trailer model may either be supplied by the trailer controller 7 during the initialization phase, or a generic model which is adapted to the real dimensions of the trailer 6 may be used. The information required for the positioning of the 3D trailer model: location, length, width and angle of the trailer may be provided by the system and the driver.

Furthermore, the length and the angle of the trailer may be enlisted in order to calculate in which direction the bowl is to be widened or expanded. Different expansions of the bowl 10, which were generated as a function of the length and orientation of the trailer 6, are depicted, by way of example, in FIGS. 7 (a)-(c). The expansion of the bowl 10 is depicted in FIG. 7 (b) and FIG. 7 (c) by means of the black arrow.

In the event that the communication only works unidirectionally (i.e., only in one direction: either from the vehicle 1 to the trailer 6 or from the trailer 6 to the vehicle 1), either the controller 7 of the trailer 6 may be used in order to make available a generic rear camera position and corresponding camera parameters which are then made available to the control device 2 of the vehicle 1, which are then used to project the generated rear view in the 3D bowl 10, or the controller 7 for the trailer 6 may be used instead of the rear camera position. The respective camera configuration may, consequently, be made available to the control device 2 of the vehicle 1.

### LIST OF REFERENCE NUMERALS

1 Vehicle
2 Control device
3a Camera
3b Camera
3C Camera
3d Camera
4 Camera sensor
5 Lidar sensor
6 Trailer
7 Controller
8a Trailer camera
8b Trailer camera
8c Trailer camera
8d Trailer camera
9 Reversing camera (3d)
10 Bowl
11 Area
12 Area

1. A camera system, in particular a surround-view camera system for a vehicle, comprising
a control device,
multiple cameras arranged in or on the vehicle, and
a controller which is arranged in or on an additional vehicle,
multiple additional cameras, arranged in or on the additional vehicle, wherein
the control device generates a view by the cameras,
the controller generates a view by means of the additional cameras, and
a combined view is generated from the views of the control device and the controller.

2. The camera system according to claim 1, wherein the view comprises at least one of a two-dimensional (2D) view or a three-dimensional (3D) view.

3. The camera system according to claim 1, wherein the views are combined taking account of at least one of a length, a width of at least one of the vehicle, or the additional vehicle.

4. The camera system according to claim 1, wherein the view is combined, taking account of an angle between the vehicle and the additional vehicle.

5. The camera system according to claim 1, wherein the combined view represents an extension, taking account of the view of the control device and/or the view of the controller.

6. The camera system according to claim 1, wherein the view generated by the controller is transmitted by the controller to the at least one controller of the control device and the control device generates the combined view.

7. The camera system according to claim 1, wherein in order to generate the view, the controller enlists a virtual camera, a position of the virtual camera substantially corresponds to a position of a first camera of the multiple cameras of the vehicle which is directed toward the additional vehicle.

8. A method for generating a three-dimensional (3D) view using a camera system for a vehicle having an additional vehicle, wherein the camera system according to claim 1 is provided as the camera system.

9. The camera system according to claim 1, wherein the additional vehicle comprises a trailer coupled to the vehicle, and the multiple additional cameras are arranged in or on the trailer.

10. The camera system according to claim 2, wherein the 2D view comprises a top view and the 3D view comprises a bowl view.
